(19) United States
(12) Patent Application Publication
(10) Pub. No.: US 2009/0044593 A1
(43) Pub. Date: Feb. 19, 2009

(54) Method and Apparatus for Calibrating a Relative Humidity Sensor

(76) Inventors: Lars Stormbom, Vantaa (FI); Matti Lyyra, Vantaa (FI); Eero Hiltunen, Klaukkala (FI)

Correspondence Address: BIRCH STEWART KOLASCH & BIRCH, PO BOX 747, FALLS CHURCH, VA, 22040-0747, US

(21) Appl. No.: 11/920,422

(22) PCT Filed: May 16, 2006
(86) PCT No.: PCT/FI2006/000157

§ 371 Date: Nov. 15, 2007

(30) Foreign Application Priority Data
May 18, 2005 (FI) 20050530

(51) Int. Cl. G01N 37/00

(52) U.S. Cl. 73/1.06

(57) ABSTRACT

The invention relates to a method for calibrating the relative content (RH) of water. According to the invention, at least one calibration point is defined at a known partial pressure (Pw) of water vapour and sensor temperature of the sensor. According to the invention, at the same known partial pressure (Pw) of water the sensor (2) is heated and, at least one increased temperature point, both the relative content (RH) and the temperature (T) are measured simultaneously.

The present invention relates to a method according to the preamble of Claim 1 for calibrating a relative-content measurement.

The invention also relates to an apparatus intended to apply the method.

There is an increasing need on the market for hygrometers with a measurement result that would be as accurate as possible and a calibration procedure that would be according to a standard and traceable. The term traceability refers to a calibration procedure, in which the calibration operations are precisely documented while the actual calibration event produces documents for later examination.

In the prior art, calibration vessels for making a precise calibration are available, in which a predefined relative content is created in saturated solutions of various salts. Non-saturated salt solutions, glycerol solutions, and hydrochloric acid solutions are also known for this purpose. The problem with these solutions has been that the correction of both a gain error and an offset has required at least two measurement stages in different calibration vessels. Each calibration stage requires a settling time, which typically varies from a few minutes to half an hour, so that in the worst case making a full calibration will require an hour's extra work. Because the measuring devices are intended for field use and calibration can take place even daily, the time used for calibration is significant. Because typically individual measuring devices are involved and the calibration vessel must be changed during calibration, it is not economically worthwhile to automate multi-vessel calibration.

In particular, automation is made difficult and expensive by the fact that the calibration vessel must be tight. This means that robotized multi-vessel calibration using this manner of implementation will be extremely expensive and unsuitable for field calibration.

A rapid field calibration method is known from U.S. Pat. No. 5,033,284, in which the temperature of a sensor element is measured and the temperature of the sensor element is deviated from the ambient temperature in order to achieve the calibration points.

A drawback with this technique is that the use of the method gives information only on the offset error. If a change takes place in the gain of the sensor, the method will not detect it. In addition, this manner of calibration is not traceable, as the content in the environment is not measured and thus not documented. Though the publication refers to a possibility of two-point calibration, this requires both heating and cooling of the sensor. Cooling in turn demands the use of an expensive cooling element.

The invention is intended to eliminate defects of the arising in the solutions described above and for this purpose to create an entirely new type of method and apparatus for the calibration of the measurement of a relative content.

The invention is based on the sensor being brought, typically in a single closed measurement vessel, to the partial pressure Pw of a known gas, at which it is heated and both the temperature of the sensor and the value proportional to the relative content are measured at the increased temperature.

Thus in the invention, for example, a known partial pressure of a gas is created in a measurement vessel, for example, by means of a saturated or unsaturated solution of salt, glycerol, or acid solution. The measuring device is first allowed to reach a state of equilibrium with the ambient temperature in the gas space in connection with this solution, in order create one calibration point. After this, the sensor, such as a humidity sensor, is heated, using an internal heating resistor, to at least one increased temperature, at which both the temperature and the reading of the relative humidity are measured and recorded. Thus additional calibration points can be created. If the source of the humidity and the temperature measurement are traceable, these new reference points will also be traceable.

More specifically, the method according to the invention is characterized by what is stated in the characterizing portion of Claim 1.

The apparatus according to the invention is, in turn, characterized by what is stated in the characterizing portion of Claim 11.

Considerable advantages are gained with the aid of the invention.

The invention also has preferred embodiments, by means of which it is possible to implement gain and offset calibration automatically, for example, after the workday. Thus the user need only place the measuring device in one calibration station and take the fully calibrated device with them at the next work shift. The sensor thus need not be transferred from one calibration vessel to another.

Using the method, it is possible to avoid the time-consuming use of several calibration vessels and to achieve an easy situation corresponding to full laboratory calibration entirely automatically.

With the aid of some embodiments of the invention, it is possible to achieve traceable multi-point calibration with minimum equipment alternations and user's work.

With the aid of preferred embodiments of the invention, a simple and rugged solution for field calibration is achieved with very little work by the user.

In the following, the invention is examined with the aid of examples and with reference to the accompanying drawings.

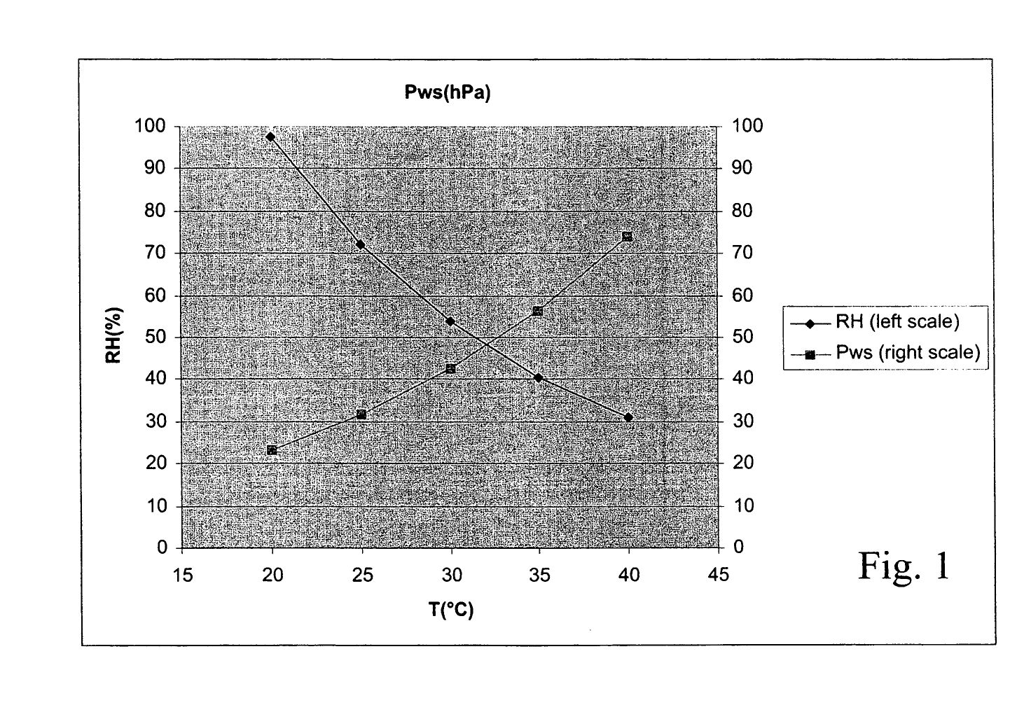

FIG. 1 shows graphically one principle according to the invention.

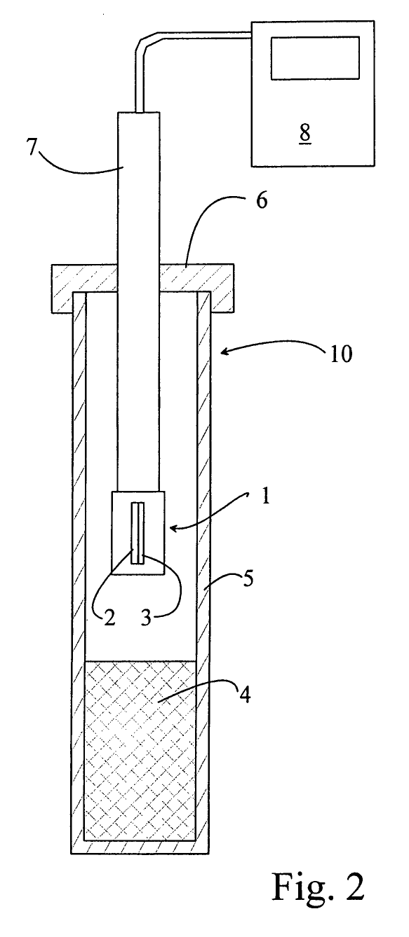

FIG. 2 shows a cross-sectional side view of one calibration apparatus according to the invention.

Relative humidity is defined as follows

RH=Pw/Pws(T)*100%, in which
Pw=partial pressure of water
Pws(T)=saturation partial pressure of water, which is a function of temperature.
Pws(T) is well known in the literature. In a closed vessel Pw remains at a constant magnitude. By heating the sensor, Pws(T) increases, in which case RH decreases. The example below, relating to FIG. 1, depicts how relative humidity changes when the sensor is heated in connection with a saturated solution of calcium sulphate (K₂SO₄):

| T | RH % | Pws (hPa) |
|---|---|---|
| 20 | 97.6 | 23.385 |
| 25 | 72.0 | 31.686 |
| 30 | 53.8 | 42.450 |
| 35 | 40.6 | 56.262 |
| 40 | 30.9 | 73.809 |

In the first measurement, the temperature of the sensor (20° C.) has been the same as the ambient temperature and the relative humidity seen by the sensor has then been 97.6%, which defines a saturated solution of calcium sulphate (K₂SO₄). Once the sensor has been heated to 25 degrees, the relative humidity seen by the sensor changes to the value 72.5 while the saturation partial pressure of water Pws/(T), obtained through the temperature measurement, is correspondingly the value 23.385 hPa. In the table and in FIG. 1, three further measurement points with a higher temperature are shown, the principle of which corresponds to the two lower points. Because in the method according to the invention the relative content of the first measurement point is known, thanks to the closed measuring vessel, and through this the saturation partial pressure of the water can be calculated precisely through the temperature, the offset and gain errors of the sensor can be corrected already with the aid of two measurement points. This naturally demands the accurate measurement of temperature.

The measurement data can be used to correct the reading of the device, in other words to correct both the offset and the gain errors. The correction can be linear, or based on a higher-degree correction algorithm.

The data of the calibration operation can be recorded in the memory of the device and possibly output. The data can include the measurement data prior to calibration and the measurement data corrected using the calibration data.

The apparatus can be used to monitor the rate of change and temperature values of the humidity/dew-point/partial pressure of gas and to automatically record information if the rates of change are below a predefined limit.

According to the invention, the sensor is heated in the calibration situation at such a low power that, in practice, it does not affect the temperature of the measurement vessel or of the gas surrounding it. The heating effect is typically less than 5 mW/° C.

The construction of the sensor should be such that the sensor measuring temperature is in very good thermic contact with the sensor measuring relative humidity. Very typically the element measuring temperature is also used as the heating element.

The sensor can be implemented, for example, as a laminar structure, in which a planar temperature sensor is placed in the immediate vicinity of a planar capacitive polymer sensor.

According to one preferred embodiment of the invention, the gas content in the calibration situation is determined with the aid of a separate precision measuring head.

Thus, according to the invention, either
I: A water solution is used, above which is formed in a state of equilibrium a known vapour pressure (which can be, for example, a saturated solution of salt, an unsaturated solution of salt, a glycerine solution, a sulphuric acid solution) in a closed vessel.
II: Pure water is a closed vessel is used. The temperature of the water can be measured using a separate temperature gauge, with the aid of which the saturation vapour pressure of the water in the chamber is measured.
III: A calibrated reference-measuring device is used. In this case field calibration can take place without removing from the process the device being calibrated.
IV: A generator producing a known vapour pressure of water is used, with the aid of which a known water vapour pressure is created around the sensor being calibrated. Known types of generator include, for example, the dual-pressure principle and the mixing principle.
The temperature of the RH sensor is measured in one of the aforementioned situations (I-IV). By heating the sensor at least two different known RH values are created, with the aid of which it is possible to correct errors of sensitivity as well as of gain and base-level offset. If desired, it is also possible to make higher-degree correction.

Alternative additional operations include:

Recording measurement data before or after in the device being calibrated. A deviation between the before/after data can be used as diagnostics information. A large difference will cause an alarm and possibly a recommendation to send the device for servicing.

The source of humidity used can be water or a water solution, which is absorbed in felt or some other water-absorbing material, so that there is no free water. It is also possible to use at least three temperatures (ambient temperature and at least two higher temperatures). The deviation of the third calibration point after the offset and sensitivity corrections is used as diagnostics information. An excessive deviation will cause an alarm and possibly a recommendation to send the device for servicing.

The output of the humidity sensor can be, for example, relative humidity, the partial pressure of a gas, a dew point, or some other quantity, as long as the sensor signal is approximately proportional to the humidity. The methods described assume that the partial pressure of the gas remains of a constant magnitude in the vicinity of the sensor during the calibration process.

According to FIG. 2, the measuring apparatus comprises a closed measuring vessel 10, which should be sufficiently tight to keep the relative content at a constant magnitude during the calibration event. The walls 5 of the vessel 10 should preferably be thermically sufficiently massive for temperature variations external to the measuring vessel 10 not to alter the temperature of the interior space of the measuring vessel 10 during the actual calibration. The change in the internal temperature of the vessel 10 should be as small as possible, typically less than 10 mK° during the actual calibration event. The sensor 1 itself a sensor 2 that is sensitive to the relative quantity, such as relative humidity, and which is typically a capacitive polymer sensor that measures relative humidity. Such a sensor 2 is thus typically a capacitor, the insulating material of which is selected in such a way that its dielectric constant is sensitive to relative humidity. In the vicinity of the humidity sensor 2 is situated a temperature measuring element 3 that is in the best possible thermic contact, and which can also act as a heating element for the thermic modulation of the humidity sensor 1. The heating element can also be a separate element. The element 3 is typically a resistor, the value of the resistance of which is sensitive to temperature. The sensor 1 is attached to a sensor body 7, which is sealed to the cover 6 of the measuring vessel 10. On the bottom of the vessel is a source of humidity 4, which can be, according to the description above, a saturated solution of salt, an unsaturated solution of salt, a glycerine solution, or a sulphuric acid solution.

The calibration event thus consists of a settling time, which is from several minutes to tens of minutes. The change in temperature can be implemented over a few minutes.

According to one preferred embodiment, the sensor's 2 heating resistor 3 is the same as the sensor's 2 temperature measuring resistor.

In the measuring apparatus, there can also be a separate temperature measuring device or arrangement, independent of the sensor 2 being calibrated, by means of which the sensor's temperature measurement offset can be eliminated. This temperature measurement is preferably traceable. The separate precision temperature-measuring device can be integrated, for example, in the measuring vessel 10, preferably in the gas space, in the vicinity of the sensor 1.

1. Method for calibrating the relative content (RH) of water, in which method at least one calibration point is defined at a known partial pressure (Pw) of water vapour and at the temperature of the sensor (2) being calibrated,
characterized in that
at the same known partial pressure (Pw) of water the sensor (2) is heated and, at least one increased temperature point, both the relative content (RH) and the temperature (T) are measured simultaneously.

2. Method according to claim 1, characterized in that the known partial pressure (Pw) of water is created using a closed measuring vessel (10), in which there is a source of humidity (4).

3. Method according to claim 1, characterized in that the known partial pressure (Pw) of water is created using a closed measuring vessel (10), in which the source of humidity is a saturated solution of salt (4).

4. Method according to claim 1, characterized in that the known partial pressure (Pw) of water is determined by measuring the partial pressure (Pw) using a separate precision measuring head.

5. Method according to claim 1, characterized in that the known partial pressure (Pw) of water is created by using a generator producing vapour pressure, with the aid of which a known partial pressure (Pw) of water vapour is created around the sensor (2) being calibrated.

6. Method according to claim 1, characterized in that the sensor (2) is heated using a heating resistor (3) connected to it.

7. Method according to claim 1, characterized in that the heating resistor (3) is the same as the sensor's temperature measuring resistor (2).

8. Method according to claim 1, characterized in that the temperature of the gas space of the measuring vessel (10) is measured using a precision gauge separate from the sensor (1).

9. Method according to claim 1, characterized in that the stability of the arrangement is monitored.

10. Method according to claim 1, characterized in that the calibration operation is arranged to be implemented automatically by a single command, for example, by pressing a button.

11. Apparatus for calibrating the measurement of relative humidity, which apparatus comprises,
a sensor (2) measuring a relative content,
a measuring device (8) connected to the sensor (2) by a data-transfer link, and
a closed measuring vessel (10), in which the sensor (2) is placed for the purpose of calibration,
characterized in that
the sensor (2) is equipped with a heating resistor (3) and the measuring device (8) correspondingly with means for feeding heating power to the resistor (3).

12. Apparatus according to claim 11, characterized in that a precision temperature sensor separate from the sensor (2) is connected to the measuring vessel (10).

13. Apparatus according to claim 1, characterized in that it comprises means for monitoring the stability of the arrangement.

14. Method according to claim 2, characterized in that the known partial pressure (Pw) of water is created using a closed measuring vessel (10), in which the source of humidity is a saturated solution of salt (4).

15. Method according to claim 2, characterized in that the sensor (2) is heated using a heating resistor (3) connected to it.

16. Method according to claim 3, characterized in that the sensor (2) is heated using a heating resistor (3) connected to it.

17. Method according to claim 4, characterized in that the sensor (2) is heated using a heating resistor (3) connected to it.

18. Method according to claim 5, characterized in that the sensor (2) is heated using a heating resistor (3) connected to it.

19. Method according to claim 2, characterized in that the heating resistor (3) is the same as the sensor's temperature measuring resistor (2).

20. Method according to claim 3, characterized in that the heating resistor (3) is the same as the sensor's temperature measuring resistor (2).
